(19) United States
(12) Patent Application Publication
(10) Pub. No.: US 2003/0207737 A1
(43) Pub. Date: Nov. 6, 2003

(54) Walking training apparatus

(76) Inventors: Tatiana Y. Sherman, Falcon, CO (US); Mark W. Sherman, Falcon, CO (US)

Correspondence Address: G.F. Gallinger, 7420 Milner Dr., #1000, Colorado Springs, CO, 80920, US

(21) Appl. No.: 10/138,831

(22) Filed: May 6, 2002

(51) Int. Cl. A61H 3/00; A47D 13/04; A63B 22/00

(52) U.S. Cl. 482/69

(57) ABSTRACT

Walking training overalls comprising: a) a body portion having a closed side having a first leg opening, and an opening side which opens to access a second leg opening; b) a back portion having shoulder straps extending to a front portion of the body portion; and c) a single hand held strap extending from a top portion of the back portion. A method of using the above overalls comprises the steps of positioning a first leg of an infant within the first leg opening by sliding the leg along an interior side portion of the body portion of the overalls; extending and then attaching end portions of the open side portion together around a second leg of the infant; positioning the shoulder straps on and over the shoulders of the infant; and finally, holding the single hand held strap to support the infant in an upright walking position.

### FIELD OF THE INVENTION

This invention relates to devices used to assist and train infants to walk. More particularly this invention relates to legless overalls which have an opening side and a single rear supporting strap.

### BACKGROUND OF THE INVENTION

Before an infant can walk independently they must progress through stages where their legs develop the strength to support their bodies, where their mind learns to coordinate movement of their legs, and where their mind learns to balance bodies above their feet. Successful walking requires a number of skills to simultaneously occur. One difficulty and deterrent in the learning process is that a large number of painful falls happen before the requisite number of skills simultaneously occur.

U.S. Pat. No. 5,356,355 issued to D. Campbell comprises a crossbar and a harness having adjustable lower and upper body belts, a crotch strap and a high back belt. One problem with this apparatus is that it is difficult for a single individual to assist an infant. Another problem is that it is difficult to have an infant correctly step through both leg openings in the bottom side portion of the harness without catching their foot or otherwise missing the leg opening defined between certain straps. What is needed is a walking training apparatus which is convenient to have an infant step into, an apparatus which does not interfere with the infant's mobility and an apparatus which is comfortable to hold and support an infant with.

### OBJECTS OF THE INVENTION

It is an object of this invention to disclose a walking training apparatus utilising legless overalls which have a side opening side and a single hand held supporting strap. With these overalls an infant can first step on the interior side of the overalls, and then slide a first foot into a first closed leg opening in the overalls. The second leg opening can be closed around their other leg merely by snapping the open side of the overall closed around their other leg. It is yet a further object of this invention to disclose a simple and convenient method of training an infant to walk using the overalls having a side opening and a single hand held strap.

One aspect of this invention provides for walking training overalls comprising: a) a body portion having a closed side having a first leg opening, and an opening side which opens to access a second leg opening; b) a back portion having shoulder straps extending to a front portion of the body portion; and c) a single hand held strap extending from a top portion of the back portion.

A method of using the above apparatus comprises the following steps: positioning a first leg of an infant within the first leg opening by sliding the leg along an interior side portion of the body portion of the overalls; extending and then attaching end portions of the open side portion together around a second leg of the infant; positioning the shoulder straps on and over the shoulders of the infant; and finally, holding the single hand held strap to support the infant in an upright walking position.

Various other objects, advantages and features of this invention will become apparent to those skilled in the art from the following description in conjunction with the accompanying drawings.

### FIGURES OF THE INVENTION

FIG. 1 is a perspective view of an infant positioned within walking training overalls.

FIG. 2 is an enlarged perspective view of the infant training overalls shown in FIG. 1.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

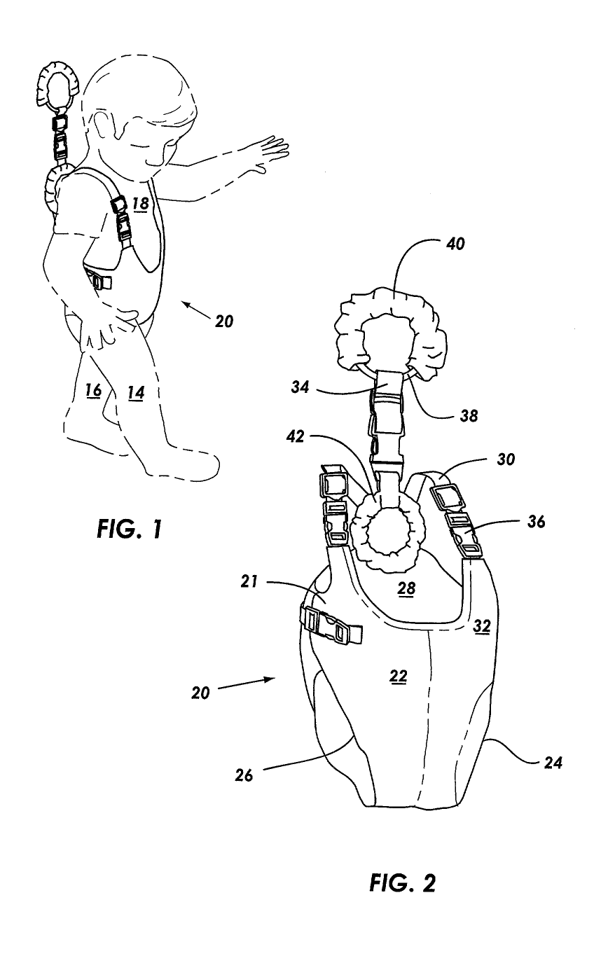

Turning now to the drawings and more particularly to FIG. 1 we have a perspective view of a an infant 18 positioned within walking training overalls 20. FIG. 2 is an enlarged perspective view of the infant training overalls 20 shown in FIG. 1. The walking training overalls 20 comprise: a) a body portion 22 having a closed side having a first leg opening 24, and an opening side which opens to access a second leg opening 26; b) a back portion 28 having shoulder straps 30 extending to a front top portion 32 of the body portion 22; and c) a single hand held strap 34 extending from a top portion of the back portion 28.

Most preferably the walking training overalls 20 are made from a continuous fabric having no openings therein which may catch the feet of an infant 18. The shoulder straps 30 and the single hand held strap 34 are adjustable for length to accommodate various sizes of infants 18 and individuals (not shown) holding the single hand held supporting strap 34.

In the most preferred embodiment of the invention the opening side portion of the body portion of the overalls 20 and one of the shoulder straps 30 on the overalls 20 are releasably held together by a quick release clasp 36 which must be squeezed to be released. In the most preferred embodiment of the invention the walking training overalls 20 further comprise a hand loop 38 which is attached to an upper end portion of the single hand held strap 34 to facilitate holding the strap 34 with a single hand. The hand loop 38 may be covered with padding 40. In the most preferred embodiment of the invention the walking training overalls 20 further comprise an additional material loop 42 which is attached to a lower end portion of the single hand held strap 34, the shoulder straps 30, and to a top portion of the back portion 28 of the overalls 20.

A method of training an infant 18 to walk comprises the following steps: providing walking training overalls 20 as described above; positioning a first leg 16 of the infant within the first leg opening 24 by sliding the leg 16 along an interior side portion of the body portion 22 of the overalls 20; extending and then attaching end portions 21 of the open side portion together around a second leg 14 of the infant 18; positioning the shoulder straps 30 on and over the shoulders of the infant 18; and finally, holding the single hand held strap 34 to support the infant 18 in an upright walking position.

While the invention has been described with preferred specific embodiments thereof, it will be understood that this description is intended to illustrate and not to limit the scope of the invention, which is defined by the following claims.

I claim:

1) Walking training overalls comprising:
a) a body portion having
a closed side having a first leg opening, and
an opening side which opens to access a second leg opening;
b) a back portion having shoulder straps extending to a front top portion of the body portion; and
c) a single hand held strap extending from a top portion of the back portion;
wherein use a first leg of an infant may be positioned on an interior side portion of the body portion of the overalls and slid therealong to be inserted within the first leg opening, thereafter end portions of the open side may be first extended and then attached around a second leg of the infant, the shoulder straps are positioned on and over the infants shoulders, and finally the infant is supported in an upright walking position by the hand held strap.

2) Walking training overalls as in claim 1 wherein the overalls are made from a continuous fabric having no openings therein which may catch the feet of an infant.

3) Walking training overalls as in claim 2 wherein the shoulder straps and the single hand held strap are adjustable for length to accommodate various sizes of infants and individuals holding the single hand held supporting strap.

4) Walking training overalls as in claim 3 wherein the opening side portion of the body portion of the overalls and one of the shoulder straps on the overalls are releasably held together by a quick release clasp which must be squeezed to be released.

5) Walking training overalls as in claim 4 further comprising a hand loop which is attached to an upper end portion of the single hand held strap to facilitate holding the strap with a single hand.

6) Walking training overalls as in claim 5 further comprising a material loop which is attached to a lower end portion of the single hand held strap, the shoulder straps, and to a top portion of the back portion of the overalls.

7) A method of training an infant to walk comprising the following steps:
providing walking training overalls having a body portion having a closed side having a first leg opening, and an opening side which opens to access a second leg opening, a back portion having shoulder straps extending to a front portion of the body portion, and a single hand held strap extending from a top portion of the back portion;
positioning a first leg of the infant within the first leg opening by sliding the leg along an interior side portion of the body portion of the overalls;
extending and then attaching end portions of the open side portion together around a second leg of the infant;
positioning the shoulder straps on and over the shoulders of the infant; and finally,
holding the single hand held strap to support the infant in an upright walking position.

8) A method as in claim 7 wherein the overalls are made from a continuous fabric having no openings therein which may catch the feet of an infant.

9) A method as in claim 8 wherein the shoulder straps and the single hand held strap are adjustable for length to accommodate various sizes of infants and individuals holding the single hand held supporting strap.

10) A method as in claim 9 wherein the opening side portion of the body of the overalls and one of the shoulder straps on the overalls are releasably held together by a quick release clasp which must be squeezed to be released.

11) A method as in claim 10 further comprising a loop which is attached to an upper end portion of the single hand held strap to facilitate holding the strap with a single hand.

12) A method as in claim 11 further comprising a loop which is attached to a lower end portion of the single hand held strap, the shoulder straps, and to a top portion of the back portion of the overalls.
